(19) United States
(12) Patent Application Publication
(10) Pub. No.: US 2019/0120132 A1
(43) Pub. Date: Apr. 25, 2019

(54) Turbocharger for an Internal Combustion Engine

(71) Applicant: Continental Automotive GmbH, Hannover (DE)

(72) Inventor: Mathias Bogner, Straubing (DE)

(73) Assignee: Continental Automotive GmbH, Hannover (DE)

(21) Appl. No.: 16/090,491

(22) PCT Filed: Mar. 8, 2017
(86) PCT No.: PCT/EP2017/055471

§ 371 Date: Oct. 1, 2018

(30) Foreign Application Priority Data
Apr. 6, 2016 (DE) 10 2016 205 643.3

(51) Int. Cl. F02B 39/12; F01D 25/14; F01D 25/16; F01D 25/26; F02C 7/06; F02C 7/24; F02C 6/12; F04D 29/05; F04D 29/26

(52) U.S. Cl. CPC F02B 39/12; F01D 25/145; F01D 25/162; F01D 25/26; F02C 7/06; F02C 7/24; F05D 2240/50; F04D 29/05; F04D 29/263; F04D 29/266; F05D 2220/40; F05D 2260/231; F05D 2300/501; F02C 6/12

(57) ABSTRACT

Various embodiments may include a turbocharger for an internal combustion engine comprising: a bearing housing with a rotor shaft mounted therein and an end shield comprising a housing end face; a turbine wheel on the rotor having a rear side facing the end shield; a turbine housing mechanically fixed to the bearing housing; a spiral path formed by the turbine housing and arranged around the turbine wheel, via which an exhaust-gas flow may supply a flow to the turbine wheel; and a first insulating element arranged in the spiral path providing thermal insulation of the turbine housing from the exhaust-gas flow, the first insulating element covering at least part of a spiral-path inner wall and comprising an integrated bearing housing heat shield providing thermal insulation of the bearing housing from the exhaust-gas flow.

### CROSS-REFERENCE TO RELATED APPLICATIONS

This application is a U.S. National Stage Application of International Application No. PCT/EP2017/055471 filed Mar. 8, 2017, which designates the United States of America, and claims priority to DE Application No. 10 2016 205 643.3 filed Apr. 6, 2016, the contents of which are hereby incorporated by reference in their entirety.

### TECHNICAL FIELD

The present disclosure relates to internal combustion engines. Various embodiments may include a turbocharger for an internal combustion engine, which has a bearing housing with a rotor shaft rotatably mounted therein and has a turbine housing with a turbine wheel arranged on the rotor shaft therein.

### BACKGROUND

Exhaust-gas turbochargers, also referred to for short as turbochargers, are used to increase power with motor vehicle internal combustion engines. They typically serve to reduce the overall size and weight of the internal combustion engine for the same power or even increased power and, at the same time, reduce fuel consumption and thus CO₂ emissions. The principle of action consists in using the energy contained in the exhaust-gas flow to increase the pressure in the intake tract of the internal combustion engine and in this way to bring about better filling of the combustion chamber with atmospheric oxygen and thus enable more fuel, e.g. gasoline or diesel, to be converted in each combustion process and thereby to increase the power of the internal combustion engine.

For this purpose, a turbocharger includes a turbine arranged in the exhaust tract of the internal combustion engine, a compressor arranged in the intake tract, and a rotor bearing in a bearing housing arranged therebetween. The turbine has a turbine housing and a turbine wheel arranged therein, which is driven by the exhaust gas mass flow. The compressor has a compressor housing and a compressor wheel, which is arranged therein and which builds up a boost pressure. The turbine wheel and the compressor wheel are arranged for conjoint rotation on opposite ends of a common shaft, the “rotor shaft”, and form what is referred to as the turbocharger rotor. The rotor shaft extends axially between the turbine wheel and the compressor wheel through the rotor bearing arranged between the turbine and compressor in a bearing housing and is provided in said bearing with rotary support in the radial and axial directions in relation to the rotor shaft rotation axis. In this construction, the turbine wheel driven by the exhaust gas mass flow drives the compressor wheel via the rotor shaft, thereby increasing the pressure in the intake tract of the internal combustion engine, based on the fresh air mass flow after the compressor, and thereby ensures better filling of the combustion chamber with atmospheric oxygen.

The turbine housing has one or more annular exhaust gas ducts, which are arranged in a ring shape around the rotor shaft rotation axis, which simultaneously represents the turbocharger axis, and the turbine wheel 12, said ducts tapering in a spiral shape toward the turbine wheel 12 and being referred to below simply as the spiral path. This spiral path has an exhaust gas supply duct oriented tangentially outward and having a manifold connection branch for connection to an exhaust gas manifold of an internal combustion engine, through which the exhaust gas mass flow flows into the spiral path. The spiral path furthermore has a slit-type opening extending at least over part of the inner circumference, referred to as the exhaust gas inlet slit, which extends at least partly in a radial direction toward the turbine wheel and through which the exhaust gas mass flow flows onto the turbine rotor.

The turbine housing furthermore has an exhaust gas discharge duct, which extends away from the axial end of the turbine rotor in the direction of the turbocharger axis and has an exhaust connection branch for connection to the exhaust system of the internal combustion engine. Via this exhaust gas discharge duct, the exhaust gas mass flow emerging from the turbine wheel is discharged into the exhaust system of the internal combustion engine.

Particularly in the case of spark-ignition engines, the turbine and the adjoining bearing housing together with the rotor shaft bearing assembly are exposed to increased, greatly fluctuating temperatures, which can go above 1000° C., owing to the higher exhaust gas temperatures in comparison with diesel internal combustion engines. This requires special measures in respect of the materials used, thermal insulation and heat dissipation.

Particularly materials that are resistant to high temperatures represent a considerable cost factor here.

### SUMMARY

The teachings of the present disclosure may be embodied in a concept for a turbocharger which contributes to low-cost production of a turbocharger. For example, some embodiments include a turbocharger (1) for an internal combustion engine, having a bearing housing (2), in which a rotor shaft (3) is mounted so as to be rotatable about a rotor shaft rotation axis (13) and which has an end shield (2a), which is designed as a housing end face arranged perpendicularly to the rotor shaft rotation axis (13); a turbine wheel (5), which is arranged for conjoint rotation on the rotor shaft (3) and has a turbine-wheel rear side (5a), which faces the end shield (2a); a turbine housing (15), which is fixed mechanically to the bearing housing (2), wherein the turbine wheel (5) is arranged in the turbine housing (15); a spiral path (16), which is formed at least partially by the turbine housing (15), is arranged around the turbine wheel (5), and via which an exhaust-gas flow can be conducted, for supplying a flow to the turbine wheel (5), and a first insulating element (18) arranged in the spiral path (16), for the thermal insulation of the turbine housing (15) with respect to the exhaust-gas flow, which covers at least part of a spiral-path inner wall (16a) and which has an integrated bearing housing heat shield (26) as an integral component, for the thermal insulation of the bearing housing with respect to the exhaust-gas flow.

In some embodiments, the integrated bearing housing heat shield (26) has, in a region radially outside the turbine wheel (5), a contour which is designed to guide the exhaust-gas flow toward the turbine wheel (5).

In some embodiments, the integrated bearing housing heat shield (26) is arranged between the end shield (2a) and the turbine-wheel rear side (5a) at least over a radial partial region of the turbine wheel (5).

In some embodiments, the first insulating element (18) is clamped firmly between the turbine housing (15) and the bearing housing (2) in the fixed state of the turbine housing (15).

In some embodiments, the first insulating element (18) has a first section (21), which is arranged in the region of the spiral path (16) and comprises an insulating material (25) for thermal insulation, and a second section (22), which adjoins the first section (21), is arranged in the region of the end shield (2a) and comprises the integrated bearing housing heat shield (26).

In some embodiments, there is a further insulating element (19), which comprises insulating material (25) for thermal insulation, and wherein the further insulating element (19) is arranged at least partially in the spiral path (16) and at least partially or completely covers the spiral-path inner wall (16a), together with the first insulating element (18).

In some embodiments, the first and the further insulating element (18, 19) are clamped firmly relative to one another between the turbine housing (15) and the bearing housing (2) in the fixed state of the turbine housing (15) on the bearing housing (2).

In some embodiments, the insulating material (25) of the first insulating element (18) and/or optionally of a further insulating element (19) is/are in each case arranged between an inner sheet-metal layer (23) and an outer sheet-metal layer (24) of the respective insulating element (18, 19), wherein the inner sheet-metal layer (23) faces the interior (20) of the spiral path (16) and the outer sheet-metal layer (24) faces the spiral-path inner wall (16a) of the spiral path (16).

In some embodiments, the inner sheet-metal layer (23) of the first section (21) of the insulating element (18) has an extension, which forms the integrated bearing housing heat shield (26) extending over the second section (22).

In some embodiments, the inner sheet-metal layer (23) is designed in such a way that it can exercise a spring effect, which acts counter to the clamping of the first and/or the further insulating element (18, 19) between the bearing housing (2) and the turbine housing (15).

### BRIEF DESCRIPTION OF THE DRAWINGS

An illustrative embodiment of the turbocharger incorporating teachings of the present disclosure is described below with reference to the attached figures. Elements that are of identical type or act identically are provided with the same reference signs throughout the figures.

In the figures:

FIG. 1 shows a partial section through a core subassembly of a turbocharger without the compressor housing and the turbine housing, consisting of the bearing housing with the rotor shaft bearing assembly and the turbocharger rotor, in accordance with the prior art; and

FIG. 2 shows an enlarged schematic section through a detail of a turbocharger containing the turbine housing with the spiral path, the bearing housing and the turbine wheel, incorporating teachings of the present disclosure.

### DETAILED DESCRIPTION

In some embodiments, a turbocharger has a bearing housing with a rotor shaft mounted therein so as to be rotatable about a rotor shaft rotation axis. The bearing housing has an end shield, which is designed as or forms a housing end face arranged perpendicularly to the rotor shaft rotation axis. The turbocharger furthermore has a turbine wheel, which is arranged for conjoint rotation on the rotor shaft and has a turbine-wheel rear side, which faces the end shield. The turbocharger furthermore has a turbine housing, which is fixed mechanically to the bearing housing, wherein the turbine wheel is arranged in the turbine housing. The turbocharger has a spiral path, which is formed at least partially by the turbine housing, arranged around the turbine wheel, and via which an exhaust gas flow can be conducted, for supplying a flow to the turbine wheel. The turbocharger includes a first insulating element arranged in the spiral path, for the thermal insulation of the turbine housing with respect to the exhaust gas flow, which covers at least part of a spiral-path inner wall and which has an integrated bearing housing heat shield as an integral component, for the thermal insulation of the bearing housing with respect to the exhaust gas flow.

The first insulating element is an element which, on the one hand, provides thermal insulation for the heat of an exhaust gas flow with respect to the turbine housing and, on the other hand, with an integrated bearing housing heat shield, prevents some heat from the exhaust gas flow being introduced via the heat shield into the bearing housing and thus into the bearing assembly of the rotor shaft. The insulating element thus has two functions, for which it has sections of different design. By means of the insulation, thermal insulation of said housing elements with respect to the heat of the exhaust gas is thus ensured, with the result that the thermal energy of the exhaust gas flow is not dissipated via the bearing housing and/or the turbine housing, in particular in the region of the spiral path and the end shield, before the flow impinges upon the turbine wheel. This would be thermodynamically undesirable since, inter alia, this energy would not be available for driving the turbine wheel. In addition, the introduction of excessive heat into the bearing assembly of the rotor shaft can be prevented by means of one insulating element and the bearing housing heat shield designed as an integral component, and therefore carbonization or other disadvantageous effects, for example, can be reduced or avoided.

The first insulating element can also be referred to as an insulating inlay or insulating insert. The first insulating element is inserted into the spiral path, for example, and thus forms the inner contour of the spiral path. In other words, the first insulating element at least partially covers the inner wall of the spiral path. To express this in yet another way, the insulating element at least partially lines the spiral path. At least on a side facing the bearing housing and/or the turbine housing, for example, the first insulating element is adapted in respect of shape to a contour of the spiral path, which may be formed by both housings, and therefore the first insulating element at least partially enters into positive engagement with the contour of the two housings.

In some embodiments, it is possible for the spiral path to be formed only partially in the turbine housing, but it is also possible for it to be formed completely by the turbine housing. In the first case, the spiral path can also be formed at least partially by the bearing housing together with the turbine housing, wherein the correspondingly shaped axial end face of the bearing housing forms the rear wall of the turbine housing, for example.

The first insulating element simultaneously combines the function of thermal insulation of the spiral path and heat shielding of the bearing housing by the bearing housing heat shield. Just one component, namely the first insulating element, instead of two individual components, has to be held ready and installed during the assembly of the turbocharger. This reduces the costs for components and assembly and allows the use of less expensive materials for the turbine housing, for example, by virtue of the lower temperature level. The smooth and uninterrupted inside of the spiral path beyond the end shield resulting from the continuous contouring of the inside of the insulating element with integrated bearing housing heat shield allows trouble-free flow guidance of the exhaust-gas flow toward the turbine wheel. This reduces flow losses and results in an improved efficiency of the turbine. At the same time, the energy loss due to cooling of the exhaust gas is reduced by the thermal insulation of the exhaust gas with respect to the housing components, likewise contributing to the increase in the efficiency of the turbine.

In some embodiments, the integrated bearing housing heat shield has, in a region radially outside the turbine wheel, a contour which is designed to guide the exhaust-gas flow toward the turbine wheel and forms at least part of a flow-guiding rear wall of the turbine housing and, in this region, covers the end shield and optionally at least part of the flange region of the bearing housing. As a result, even regions of the end shield of the bearing housing which may be situated radially outside the turbine-wheel rear side are thermally shielded, and this allows continuous, low-loss flow guidance of the exhaust-gas flow into the immediate vicinity of the blading of the turbine wheel, in this way contributing to the avoidance of efficiency losses due to flow losses and flow behind the turbine wheel.

In some embodiments, the integrated bearing housing heat shield (26) is arranged between the end shield and the turbine-wheel rear side at least over a radial partial region of the turbine wheel. Excessive heating of the region of the end shield which is close to the bearing and thus of the rotor shaft bearing is thereby prevented in a particularly effective manner.

In some embodiments, the first insulating element is clamped firmly between the turbine housing and the bearing housing in the fixed state of the turbine housing, in the assembled state of the turbine. This makes it possible to mechanically fix the insulating element in a secure way in the turbocharger without additional elements, such as fastening elements or the like. As an option, the clamping action ensures that the insulating element, in particular the bearing housing heat shield, is preloaded and can thus achieve a spring action. In some embodiments, the spring action helps during operation since the bearing housing heat shield expands during operation in accordance with the high prevailing temperatures, wherein the possibilities of the elastic deflection that are available make it possible to avoid deformation of the bearing housing heat shield.

In some embodiments, the first insulating element has a first section, which is arranged in the region of the spiral path (16) and comprises an insulating material for thermal insulation, and a second section, which adjoins the first section, is arranged in the region of the end shield and comprises the integrated bearing housing heat shield. By virtue of the spatial division of the first insulating element into two sections, the two functions, as explained at the outset, can be implemented.

In some embodiments, the first section is arranged in such a way that it reduces the heat input into the spiral-path or turbine-housing rear wall formed by a flange region of the bearing housing or by the turbine housing itself. As the primary means of achieving this, the first section is arranged in the spiral path. The second section with the integrated bearing housing heat shield extends beyond the end shield of the bearing housing, for example, and between the turbine-wheel rear side and the end shield of the bearing housing in order to prevent heat being introduced into the bearing housing there. The insulating material mentioned is a ceramic material, woven glass fiber material or some other material with thermal insulation properties, for example.

In some embodiments, the turbocharger has a further insulating element, which likewise comprises insulating material for thermal insulation. In this case, the further insulating element is arranged at least partially or even completely in the spiral path and, together with the first insulating element, covers the spiral-path inner wall at least partially or even completely. It is also possible for the first and the second insulating element to be considered jointly as a two-part insulating element. Accordingly, the insulating element would have a first and a further component element, wherein the first component element of the insulating element is subdivided into a first and a second section, and wherein the first section of the first component element of the insulating element comprises an insulating material for thermal insulation and is arranged in the spiral path, and the second section of the first component element of the insulating element has the integrated bearing housing heat shield. The further insulating element or further component element thus has the function of thermal insulation of the spiral path, while the first insulating element or first component element performs both the function of thermal insulation of the spiral path and thermal insulation of the integrated bearing housing heat shield.

Full thermal insulation of the spiral path and of the bearing housing can be produced separately in a simple manner and can be installed in a small number of assembly steps during the assembly of the turbocharger. In this way, the first insulating element with the insulating material and the integrated bearing housing heat shield can first of all be inserted in a simple manner between the turbine wheel and the bearing housing. The further insulating element is then inserted, for example, into the further part of the spiral path, which is formed in the turbine housing. By joining the turbine housing and the bearing housing to the respective insulating element, the turbine of the exhaust-gas turbocharger is then assembled, wherein the first and the further insulating element or the two component elements of the insulating element are fixed relative to one another and in the spiral path by being joined together during assembly. The two insulating elements or two component elements of the insulating element thus together line the spiral path at least in part, in particular however completely, as described above, and thus together cover the spiral-path inner wall at least partially or completely.

In some embodiments having a first and a further insulating element, the first and the further insulating element or the two component elements of the insulating element are trapped or clamped firmly relative to one another between the turbine housing and the bearing housing in the fixed state of the turbine housing on the bearing housing in the assembled state of the turbine. In particular, a clamping action is produced by means of the first insulating element and the further insulating element and the connection thereof to the bearing housing and the turbine housing. This represents a particularly simple and low-cost method of fixing the insulating elements in the turbine housing, in which there is no need for any additional fastening means.

In some embodiments, the insulating material of the first insulating element and/or, where present, of a further insulating element is/are arranged between an inner sheet-metal layer and an outer sheet-metal layer of the corresponding insulating element, wherein the inner sheet-metal layer faces the interior of the spiral path and the outer sheet-metal layer faces the spiral-path inner wall of the spiral path. In other words, the insulating material is encapsulated by both sheet-metal layers. The insulating material is thereby protected from physical/mechanical effects in the spiral path of the turbine housing. In other words, the insulating material of the first section of the first insulating element or the insulating material of the further insulating element is in each case arranged in a casing or capsule formed by the sheet-metal layers.

In some embodiments, in which the insulating material is arranged between sheet-metal layers, the inner sheet-metal layer of the first section of the first insulating element has an extension, which forms the integrated bearing housing heat shield extending over the second section (22). In this case, the inner sheet-metal layer is simply extended radially inward, with the result that it extends at least over part of the end shield of the bearing housing. The insulating material is thereby encapsulated together with the outer sheet-metal layer in the first section, and an integrated bearing housing heat shield is formed in the second section. In this way, there is no need for a separately produced connection between the first and the second section of the first insulating element.

In some embodiments, the inner sheet-metal layer is designed in such a way that it can exercise a spring effect, which acts counter to the clamping of the first and/or the further insulating element (18, 19) between the bearing housing (2) and the turbine housing (15) and thus produces a defined clamping force. In other words, the integrated bearing housing heat shield is of sprung configuration. For example, the inner sheet-metal layer is of thicker design than the outer sheet-metal layer to enable the spring action and the clamping or clamping action to be achieved. In some embodiments, the turbine housing is of one-piece design. This is intended to mean that the turbine housing is configured as a one-piece casting, for example. In some embodiments, the turbine housing does not have a separate rear wall of the spiral path but the spiral-path rear wall is formed by a flange region of the bearing housing, for example. It is thereby possible to avoid undercuts, which can be a hindrance in the production of the casting. Here, a first insulating element which has the integrated bearing housing heat shield as an integral component is advantageous since pre-installation of the first insulating element, i.e. of the integrated bearing housing heat shield, on the bearing housing independently of the turbine housing and, at the same time, thermal insulation at least of the spiral-path rear side, i.e. of the spiral-path inner wall situated on the bearing housing side, can be performed in a simple manner.

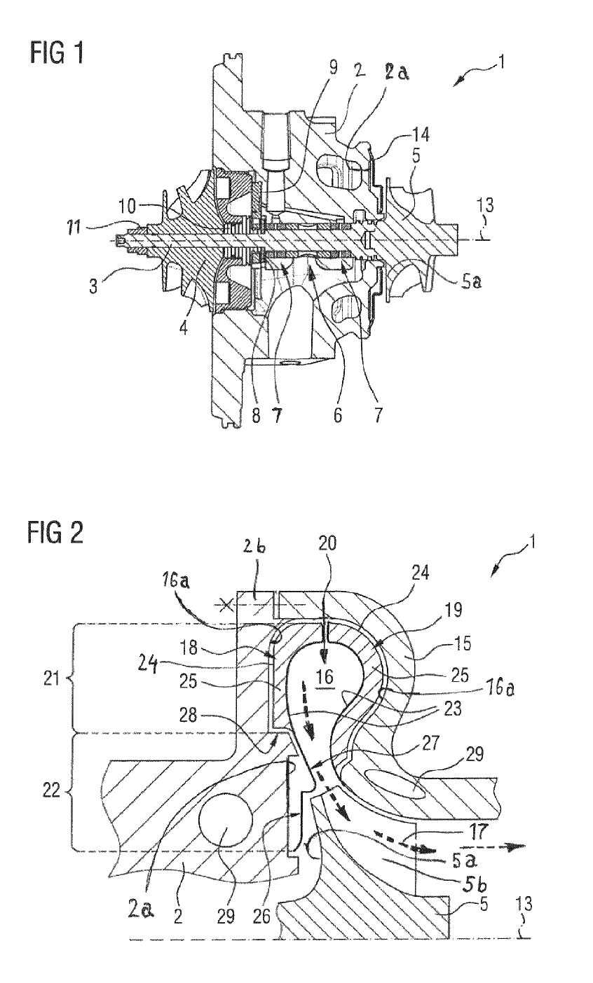

FIG. 1 shows a section through a core subassembly of a turbocharger 1, in particular of an exhaust-gas turbocharger, in particular for the internal combustion engine of a motor vehicle, comprising the bearing housing 2 and the turbocharger rotor with the turbine wheel 5, compressor wheel 4 and rotor shaft 3, which is described below by way of example. The compressor housing and the turbine housing are not shown in this figure. The turbocharger 1 is provided for an internal combustion engine, also referred to as a combustion motor, in particular for a reciprocating-piston combustion motor. The turbocharger 1 has a bearing housing 2, in which a rotor shaft 3, which is also referred to as a turbocharger shaft, is rotatably mounted.

A compressor wheel 4 for a compressor, which is fixed on the rotor shaft, is provided on one end of the rotor shaft 3. A turbine wheel 5 for an exhaust-gas turbine, which is likewise fixed on the rotor shaft 3, is provided on the opposite end of the rotor shaft 3. During the operation of the turbocharger 1, said turbocharger is arranged on the internal combustion engine in such a way that the turbine wheel 5 is arranged in the exhaust line and the compressor wheel 4 is arranged in the fresh-gas line of the internal combustion engine.

During the operation of said internal combustion engine or combustion motor, an exhaust-gas flow in the exhaust line drives the turbine wheel 5, which drives the compressor wheel 4 via the rotor shaft. The compressor wheel 4 compresses fresh gas that is situated in the fresh-gas line before said fresh gas is supplied to the cylinder of the internal combustion engine. It is thus possible to increase an efficiency of the internal combustion engine.

The components of the turbocharger 1 which are described below are typically mounted in the bearing housing 2 or on the rotor shaft 3 from the compressor side. Accordingly, the rotor shaft 3 tapers in the direction of the compressor via a plurality of shaft offsets in order to allow assembly.

The rotor shaft 3 is mounted so as to be rotatable around a rotor shaft rotation axis 13 of the rotor shaft 3 by means of two oil-lubricated radial bearings 7 fitted in a hole 6 in the bearing housing 2. Here, a shaft offset on the rotor shaft 3 prevents slipping of the radial bearing 7 on the right in FIG. 1 in the direction of the turbine wheel 5. Adjoining the radial bearing 7 on the left in FIG. 1 there is an axial bearing washer 8, which is positioned on a further shaft offset on the rotor shaft 3.

A sealing bush 10 having an integrated further axial bearing washer is arranged on the rotor shaft 3, adjoining axial bearing washer 8. An axial counter bearing 9 fixed in relation to the housing is arranged in the bearing housing 2 between said axial bearing washers. The axial counter bearing 9 is designed to absorb axial forces which act on the rotor shaft 3 by means of the two axial bearing washers.

The compressor wheel 4 is arranged on the rotor shaft 3, resting against the sealing bush 10, and, in the illustrative embodiment, is screwed against the sealing bush 10, axial bearing washer 8 and thus against the corresponding shaft offset on the rotor shaft 3 by means of a shaft nut 11. The compressor wheel 4, the sealing bush 10 and axial bearing washer 8 are thereby clamped fast between the corresponding shaft offset and the shaft nut 11.

The high temperatures of the exhaust-gas flow passed across the turbine wheel give rise to a large heat input into the bearing housing 2, particularly into the described bearing assembly of the rotor shaft 3. This can lead to carbonization of the oil in the bearings 7 and, as a result, to damage or even failure of the bearings 7. In order to reduce or largely avoid this heat input, the turbocharger 1 furthermore has a conventional bearing housing heat shield 14. This conventional bearing housing heat shield 14 is of disk-type design with a plurality of steps and has a central opening, by means of which it is pushed onto a fastening collar of the bearing housing 2. In the assembled state, part of the conventional bearing housing heat shield 14 extends, as shown, into an interspace between the turbine-wheel rear side 5a and the end shield 2a of the bearing housing 2. The end shield 2a is the axial end face of the bearing housing 2, which is arranged substantially perpendicularly to the rotor shaft rotation axis 13 and is optionally of stepped design. In this case, the conventional bearing housing heat shield 14 forms a cover of the end shield 2a, which has the function of heat shielding. The conventional bearing housing heat shield 14 is clamped axially to the bearing housing 2 by fixing a turbine housing (not shown in FIG. 1), in particular by means of one or more flanges of the turbine housing.

FIG. 2 shows an enlarged schematic section through a detail of a turbocharger 1, which comprises part of the turbine housing 15, part of the bearing housing 2, the spiral path 16 formed by the turbine housing 15 and the bearing housing 2, and part of the turbine wheel 5. The turbocharger 1 corresponds very largely, in particular functionally, to the embodiment shown in FIG. 1 but differs through the features and the design configuration of the construction.

Here, the turbine housing 15 of the turbocharger 1 is produced from a light metal material, such as aluminum, for example, which is cheaper and also lighter than a casting material resistant to high temperatures but is not resistant to high temperatures and absorbs heat more quickly from the interior of the turbine housing 15. The turbine housing 15 is firmly connected mechanically, in particular screwed, to the bearing housing 2 by means of an (external) flange region 2b of the bearing housing 2. With the bearing housing 2, in particular with the flange region 2b of the bearing housing 2, the turbine housing 15 forms a spiral path 16, via which the exhaust-gas flow is conducted to the turbine wheel 5 so as to impinge upon the latter during the operation of the turbocharger 1. The exhaust-gas flow, here indicated by dashed arrows 17, then flows axially out of the turbine housing 15 in the direction of the rotor shaft rotation axis 13.

To ensure that the thermal energy is not absorbed and dissipated, or only insignificantly absorbed and dissipated, by the bearing housing 2 and the turbine housing 15 before the exhaust-gas flow impinges upon the turbine wheel 5, the spiral path 16 is lined at least partially, but in this case fully, with insulating elements 18, 19. The insulating elements 18 and 19 are formed around the circumference of the spiral duct 16 and are arranged concentrically with respect to the rotor shaft rotation axis 13. The two insulating elements 18 and 19, which can also be referred to as insulating inlays, insulating layers or insulating coats, line the spiral path 16, at least partially according to the invention, but in this illustrative embodiment fully, and are arranged in such a way that they cover the spiral-path inner wall 16a almost without a transition. For this purpose, the shaping of the first insulating element 18 and of the further insulating element 19 is matched to the contour of the spiral-path inner wall 16a of the spiral path 16, as shown in FIG. 2. The two insulating elements 18, 19 can also be regarded as one insulating element which is divided essentially into halves over the circumference.

The first insulating element 18 has a first section 21 and a second section 22. The first section 21 serves as thermal insulation for that part of the spiral-path inner wall 16a which is situated on the same side as the bearing housing 2, which can also be referred to as the spiral-path rear wall and, in this illustrative embodiment, is formed by the flange region 2b of the bearing housing 2. At the same time, the first insulating element 18 fits over part of the turbine housing 15 in the axial direction of the rotor shaft rotation axis and thus also serves for thermal insulation of this region of the turbine housing 15. The first section 21 comprises an insulating material 25, which is arranged between an inner sheet-metal layer 23 and an outer sheet-metal layer 24, wherein the inner sheet-metal layer 23 faces the interior 20 of the spiral path 16 and thus faces the exhaust-gas flow during the operation of the turbocharger 1, and wherein the outer sheet-metal layer 24 faces the spiral-path inner wall 16a of the bearing housing 2 and/or of the turbine housing 15. In other words, the sheet-metal layers 23, 24 form a sheet-metal casing which bounds or surrounds or encapsulates the insulating material 25. For this purpose, the two sheets-metal layers 23, 24 are connected to one another for example, e.g. spot-welded. The insulating material 25 is ceramic, woven glass fiber material or, alternatively, some other material with a thermal insulating action, for example.

In some embodiments, the second section 22 of the first insulating element 18 has an integrated bearing housing heat shield 26. For this purpose, the inner sheet-metal layer 23 in this illustrative embodiment, which covers the insulating material 25 of the first section, is simply extended and thus has an extension, which serves as an integral bearing housing heat shield 26 that, according to the invention, at least partially covers the end shield 2a of the bearing housing 2. Thus, the first insulating element has the integral bearing housing heat shield 26 as an integral component. In some embodiments, the integral bearing housing heat shield 26 is extended radially inward, toward the rotor shaft rotation axis 13, as far as the interspace between the end shield 2a and the turbine-wheel rear side 5a and thus covers the end shield 2a almost completely.

Radially outside the turbine-wheel rear side 5a, the integrated bearing housing heat shield 26 has a flow-guiding region 27, which has a contour that is designed to guide the exhaust-gas flow toward the turbine wheel and thus, at the same time, serves as a guide element for the exhaust-gas flow in the direction of the blading 5b of the turbine wheel 5 in order to guide the flow out of the spiral path 16 onto the turbine wheel 5, in particular at a certain angle relative to the rotor shaft rotation axis 13. In this way, the integrated bearing housing heat shield 26 thus as it were forms at least part of a flow-guiding rear wall of the turbine housing 15 and, in this region, covers the end shield 2a and optionally at least part of the flange region 2b of the bearing housing 2.

The further insulating element 19 is designed to correspond to the first section 21 of the first insulating element 18 and serves exclusively for the thermal insulation of the turbine housing 15 by means of the insulating material 25. In other words, the first insulating element 18 on the bearing-housing side incorporates the integrated bearing housing heat shield 26, while the turbine-housing-side further insulating element 19 serves for the thermal insulation of the turbine-housing-side inside of the spiral path.

The inner sheet-metal layer 23 of both insulating elements 18, 19, which faces the interior 20 of the spiral path 16, in particular that of the first insulating element 18, is designed in such a way in respect of the thickness thereof that a spring action can be produced. As described at the outset, this is necessary in order to allow tolerance compensation and thermal expansion during operation. For example, the inner sheet-metal layer 23 has a thickness or wall thickness of 0.8 mm, and the outer sheet-metal layer 24 has a corresponding thickness or wall thickness of 0.2 mm.

For the assembly of the turbocharger 1 in this illustrative embodiment, the first insulating element 18 is first of all laid on the end shield of the bearing housing 2 and centered by means of an encircling fastening collar formed on the end shield 2a or mounted on said collar, for example. The main body assembly of the turbocharger 1 is then assembled, inter alia by inserting the turbine wheel 5 with the rotor shaft 3 into the bearing housing 2. The first insulating element 18 is thus situated at least partially in the interspace between the end shield 2a of the bearing housing and the turbine-wheel rear side 5a. The further insulating element 19 is then placed in the turbine housing 15, in that section of the spiral path 16 which is on the turbine-housing side. Following on from this, the turbine housing 15 is then combined with the bearing housing 2 and mechanically fixed, e.g. screwed, on the flange region 2b of the bearing housing 2. By corresponding dimensional configuration of the insulating elements and the screw fastening, a clamping effect is produced on both insulating elements 18 and 19 via the turbine housing 15 and the bearing housing 2, thus ensuring that the insulating elements 18, 19 are fixed or clamped securely by mechanical means.

In some embodiments, cooling ducts 29, in which a cooling medium, such as water, flows to absorb and carry away thermal energy, can be provided in the bearing housing 2 and in the turbine housing 15. It is thereby possible to further reduce the temperature level in the bearing housing 2 and in partial regions of the turbine housing 15, which has a positive effect on wear and on excessive component stresses due to the thermal energy introduced.

In some embodiments, in place of the cooling duct 29 in the turbine, to extend the second insulating element 18 beyond this region denoted as sealing contour 30 in the direction of the turbine wheel 5 or to provide another insulating element.

In some embodiments, the first insulating element with the integrated bearing housing heat shield 26 makes possible the advantages mentioned at the outset in respect of low-cost production and assembly of the turbocharger 1. In particular, the turbine housing 15 can be one piece, as described above, which makes possible methodological advantages and reduced costs in the production of the turbine housing. Moreover, the turbine housing 15 can be produced from a lighter, cheaper material in comparison with a casting material resistant to high temperatures. In addition, the obstacle-free flow routing and the lower temperature loss of the exhaust-gas flow has a positive effect on the efficiency of the turbocharger.

Attention may be drawn at this point to the fact that, as regards design configurations and the presence of the elements described, such as the bearing assemblies or the like, the turbocharger 1 described with reference to FIGS. 1 and 2 should be understood as an illustrative embodiment, which is not in the first instance intended to restrict the subject matter of the disclosure beyond the scope of the main claim.

What is claimed is:

1. A turbocharger for an internal combustion engine, the turbocharger comprising:
a bearing housing with a rotor shaft mounted therein so as to rotate about a rotor shaft rotation axis and an end shield comprising a housing end face perpendicular to the rotor shaft rotation axis;
a turbine wheel rotating on the rotor shaft having a rear side facing the end shield;
a turbine housing mechanically fixed to the bearing housing, wherein the turbine wheel is arranged in the turbine housing;
a spiral path formed at least in part by the turbine housing and arranged around the turbine wheel, via which an exhaust-gas flow may supply a flow to the turbine wheel; and
a first insulating element is arranged in the spiral path providing thermal insulation of the turbine housing from the exhaust-gas flow, the first insulating element covering at least part of a spiral-path inner wall and comprising an integrated bearing housing heat shield providing thermal insulation of the bearing housing from the exhaust-gas flow.

2. The turbocharger as claimed in claim 1, wherein the integrated bearing housing heat shield includes, in a region radially outside the turbine wheel, a contour guiding exhaust-gas toward the turbine wheel.

3. The turbocharger as claimed in claim 1, wherein the integrated bearing housing heat shield is arranged between the end shield and the turbine-wheel rear side over at least a radial partial region of the turbine wheel.

4. The turbocharger as claimed in claim 1, wherein the first insulating element is clamped firmly between the turbine housing and the bearing housing in a fixed state of the turbine housing.

5. The turbocharger as claimed in claim 1, wherein the first insulating element includes:
a first section arranged in the region of the spiral path and comprising an insulating material for thermal insulation; and
a second section adjoining the first section arranged approximate the end shield and comprising the integrated bearing housing heat shield.

6. The turbocharger as claimed in claim 5, further comprising a second insulating element including insulating material for thermal insulation; and
wherein the second insulating element is arranged at least partially in the spiral path and at least partially covers the spiral-path inner wall.

7. The turbocharger as claimed in claim 6, wherein the first insulating element and the second insulating element are clamped firmly relative to one another between the turbine housing and the bearing housing in a fixed state of the turbine housing on the bearing housing.

8. The turbocharger as claimed in claim 1, wherein the insulating material is arranged between two sheet metal layers.

9. The turbocharger as claimed in claim 8, wherein an inner sheet-metal layer of the first section of the insulating element includes an extension forming the integrated bearing housing heat shield extending over the second section.

10. The turbocharger as claimed in claim 8, wherein an inner sheet-metal layer provides a spring effect counter to the clamping of the insulating element between the bearing housing and the turbine housing.
